(19) United States
(12) Patent Application Publication
(10) Pub. No.: US 2019/0003637 A1
(43) Pub. Date: Jan. 3, 2019

(54) CONCEALED MOUNTING BRACKET

(71) Applicant: ALLPRO MANUFACTURING, INC., Houston, TX (US)

(72) Inventor: Cary Ostera, Houston, TX (US)

(21) Appl. No.: 16/126,709

(22) Filed: Sep. 10, 2018

Related U.S. Application Data
(63) Continuation-in-part of application No. 14/712,693, filed on May 14, 2015, now Pat. No. 10,072,873.
(60) Provisional application No. 61/993,644, filed on May 15, 2014.

(51) Int. Cl. F16M 13/02; A47G 1/16; A47B 95/00; F16B 15/00

(52) U.S. Cl. CPC F16M 13/02; F16B 15/00; A47B 95/008; A47G 1/1613

(57) ABSTRACT

A concealed mounting bracket configured to be mounted to studs of a framed structure. The bracket can have a support and a pin. The pin can be configured to punch through drywall as the drywall is installed.

### CROSS REFERENCE TO RELATED APPLICATION

The current application is a Continuation in Part and claims priority to and the benefit of co-pending U.S. patent application Ser. No. 14/712,693 filed on May 14, 2015, titled “TANKLESS WATER HEATER CARRIER”, which claims priority to U.S. Provisional Patent Application Ser. No.: 61/993,644 filed on May 15, 2014, titled “TANKLESS WATER HEATER CARRIER”. These references are hereby incorporated in their entirety.

### FIELD

The embodiments generally relate to a concealed mounting frame for supporting equipment through drywall.

### BACKGROUND

Many pieces of equipment require a mounting bracket for support, proper orientation, or other reasons. Often, these brackets are eyesores and cosmetically undesirable.

There is a need, therefore for a frame which is easy to install, capable of supporting heavy loads, and versatile for many different types and sizes of equipment.

The present disclosure allows for a heavy-duty mount usable for equipment without undesirable cosmetic features in view.

### BRIEF DESCRIPTION OF THE DRAWINGS

The detailed description will be better understood in conjunction with the accompanying drawings as follows:

FIG. 1 depicts an embodiment of the concealed mounting bracket.

FIG. 2A depicts an embodiment of a pin.

FIG. 2B depicts an embodiment of a pin.

FIG. 2C shows a front view of the pin shown in FIG. 2B.

FIG. 2D shows a front view of an embodiment of a pin.

FIG. 2E depicts an embodiment of a pin.

FIG. 2F depicts an embodiment of a pin.

The present embodiments are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about” means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a concealed mounting bracket.

The bracket can support heavy equipment, or other items needing to be affixed to a wall while being completely concealed behind drywall.

While equipment is referenced in this disclosure, the bracket can be used to mount and support any item near a wall. For example, decorative items, art, shelving, electronics and electronic components, and the like can all utilize embodiments of the present disclosure.

Further, while drywall is referenced, the disclosure is intended to include any manner of covering for a framed structure, including but not limited to: drywall, sheetrock, wooden paneling, vinyl or other synthetic paneling, brick veneer, and the like.

The concealed mounting bracket can comprise a support and a pin.

The support can be configured to fasten to a stud of a framed structure. The support is intended to be secured to the structure, while being hidden by a covering of the frame, such as drywall. Drywall as used within this disclosure refers to any frame covering material or wall materials used by persons having ordinary skill in the art.

The support can be recessed in areas to avoid or minimize contact with drywall. The support can have one or more mounting holes for fastening the support to a stud of a framed structure. Any fastener commonly used by phosita can be used for this purpose, such as nails, screws, and the like.

The support can have a telescoping member in embodiments, to allow for adjustment when studs are spaced at non-standard distances. The support can have a slider either hung or fastened to the support at a user selected width.

In instances where multiple supports are needed, a separator can be used to space, orient, and align the supports from each other as desired. Phosita can select a desired number of supports, separators, and sliders as needed for any given mounting configuration.

The pin can be fastened to the support at one end and comprise a sharp edge at an opposite end. The sharp edge, or point, can be configured to punch through drywall as the drywall is mounted to the stud.

The pin can be fastened to the support, held by the slider, or fastened to the slider. The sharp edge or point need not be centered to the axis of the pin. In order to minimize the hole size in drywall, the sharp edge of the pin can be offset. In other embodiments, the pin can contain a bend for this purpose.

In embodiments, the pin can be made of two pieces comprising a pin head and a pin shank. In embodiments, the pin can also comprise a thread at one or both ends.

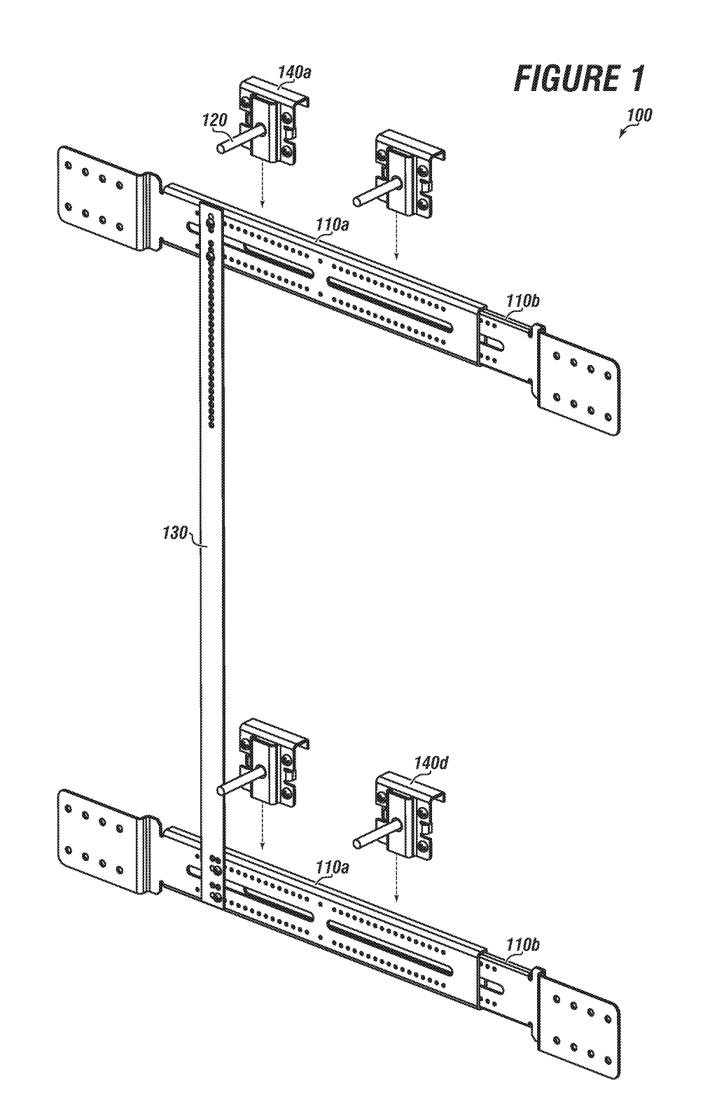

Turning now to the Figures, FIG. 1 depicts an embodiment of the concealed mounting bracket.

The concealed mounting bracket 100 can have a support 110a. The support 110a can have a telescoping member 110b. Pin 120 is shown held in place by a slider 140a. In embodiments, the pin 120 can be fastened to the slider 140a or the support 110a. Pin 120 is preferably threaded as a fastening method.

A separator 130 can be used to space, orient, and align multiple supports 110a if used.

In embodiments, at least one support and at least one telescoping member can be used. In embodiments, multiple supports can be used. In embodiments, multiple telescoping members can be used.

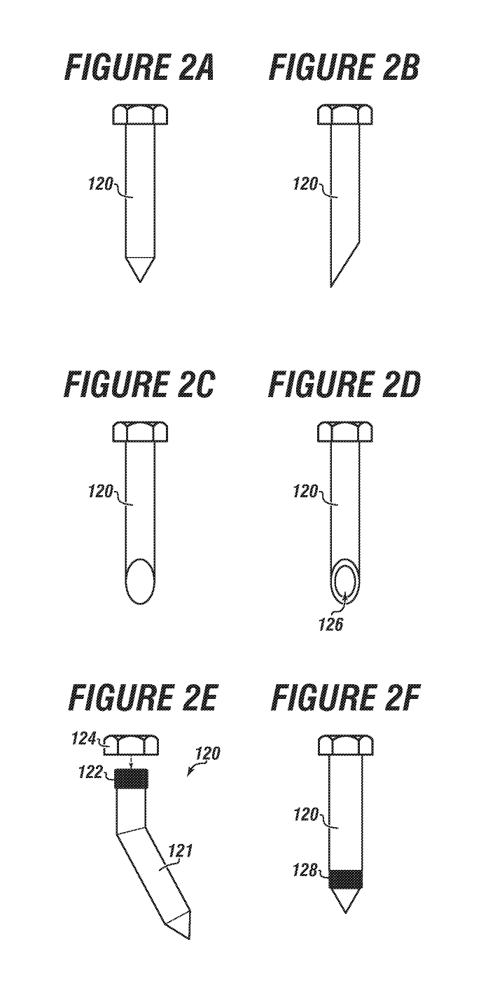

FIG. 2A depicts an embodiment of a pin. Shown here is pin 120 with a sharp point centered on the axis of the pin. The point can help to punch through drywall as it is mounted to the studs.

FIG. 2B depicts an embodiment of a pin. Shown here is pin 120 with a sharp point not centered on the axis of the pin. The point can help to punch through drywall as it is mounted to the studs, while minimizing the size of the hole made in the drywall.

FIG. 2C shows a front view of the pin shown in FIG. 2B.

FIG. 2D shows a front view of an embodiment of a pin. In this embodiment, pin 120 can have a hollow 126, have a hollow portion or be hollow, allowing for drywall material to enter the pin as it is installed.

FIG. 2E depicts an embodiment of a pin. Here, pin 120 is comprised of two pieces, pin shank 121 and pin head 124. Pin 120 has a thread 122 for attachment to either the slider or the support. Pin 120 here comprises a bend for minimizing the size of the hole made in the drywall. Pin 120 can be threaded directly into the slider or the support without using the pin head in embodiments.

FIG. 2F depicts an embodiment of a pin. Here, pin 120 comprises a thread 128 proximate the sharp edge, allowing for a nut to be threaded on to the pin.

While the present disclosure emphasizes the embodiments, it should be understood that within the spirit and scope of the appended claims, the invention might be practiced other than as specifically described herein.

What is claimed is:

1. A concealed mounting bracket comprising:
a) a support configured to be fastened to a stud of a framed structure; and
b) a pin fastened to the support at a first end, wherein the pin comprises a sharp edge at a second end opposite the first end configured to punch through drywall when the drywall is mounted to the stud.

2. The concealed mounting bracket of claim 1, wherein the support comprises a telescoping member.

3. The concealed mounting bracket of claim 1, further comprising a slider on the support, wherein the pin fastens to the slider.

4. The concealed mounting bracket of claim 1, further comprising a separator configured to fasten to the support.

5. The concealed mounting bracket of claim 1, wherein the pin comprises a pin head and a pin shank.

6. The concealed mounting bracket of claim 1, wherein the sharp edge is not centered on the axis of the pin.

7. The concealed mounting bracket of claim 1, wherein the pin comprises a bend.

8. The concealed mounting bracket of claim 1, wherein the pin threadably engages the support.

9. The concealed mounting bracket of claim 3, wherein the pin threadably engages the slider.

10. The concealed mounting bracket of claim 1 wherein the pin comprises a thread proximate the sharp edge.
